(19) United States
(12) Patent Application Publication
(10) Pub. No.: US 2011/0123284 A1
(43) Pub. Date: May 26, 2011

(54) REAMER TOOL

(75) Inventor: Charles H. Riedy, Lakewood, OH (US)

(73) Assignee: THOMAS & BETTS INTERNATIONAL, INC., Wilmington, DE (US)

(21) Appl. No.: 12/623,187

(22) Filed: Nov. 20, 2009

(51) Int. Cl. B23D 77/00

(52) U.S. Cl. 408/230; 408/227

(57) ABSTRACT

An improved reamer tool is described that has lower torque requirements, despite having more blades. Because of the lower torque requirements, the reamer can be used with a handheld drill. The reamer uses fewer cutting edges and has blades that do not extend into the material of the pipe.

### FIELD OF THE INVENTION

The present invention is generally directed toward an apparatus for increasing the internal diameter of a hole.

### BACKGROUND OF THE INVENTION

Reamer tools are used to increase the inner diameter of holes, pipes, or conduit by removing material from the inner surface. Previously-known reamer tools, such as that disclosed in U.S. Pat. No. 7,513,719 to Keiper, use various configurations of blades which mill away the inside of the pipe as the reamer rotates. For portability and convenience, some reamers are mounted on a drill or other rotary drive; however, most of these are only suitable for increasing the size of smaller holes.

Increasing the diameter of larger holes presents additional problems for drill mounted reamers. Larger holes allow for more side-to-side and wobble movement by reamers, especially when starting. This wobble can result in gouged sidewalls and poor finishes on the sidewall of the reamed hole. To address this issue, the prior art reamers required additional blades and cutting edges to mill away the material on the inside of the pipe. The additional blades provided stability for the reamer and prevented axial wobble, while increasing the number of cutting surfaces. However, adding additional blades resulted in higher torque requirements due to the additional cutting edges, the additional weight, and the increased surface contact with the sidewalls of the holes. This increased torque requirement made these reamers unsuitable for use with standard handheld drills. The improved reamer tool disclosed herein solves this problem by decreasing the torque requirements compared to that of previously-known reamer tools, thus allowing the use of handheld drills and other low torque motors.

### SUMMARY OF THE INVENTION

An improved reamer tool with low torque requirements is disclosed. This improved reamer has additional blades to provide stability, but does not suffer from higher torque requirements. As a result, the reamer tool can be used with weaker rotary drive motors, such as a handheld drill.

The claimed device comprises a cutter assembly having a rotational axis, a plurality of blades formed in the cutter assembly positioned about the rotational axis, and cutting faces on all of the blades in said plurality of blades, said cutting faces configured to remove material from the inner surface of said hole. Various configurations are also disclosed, including having a chamfered edge on the blades, a shaft for attaching to a handheld drill, a pilot plate and stop plate, a tapered form, and a configuration with grooves on the blades in a stepped spiral shape.

### BRIEF DESCRIPTION OF THE DRAWINGS

Further advantages of the invention will become apparent by reference to the detailed description of preferred embodiments when considered in conjunction with the drawings:

FIG. 1 depicts a perspective view of the reamer tool.

FIG. 2 is a side elevation view of the cutter assembly of the reamer tool.

FIG. 3 is a sectional viewing of the cutter assembly of the reamer tool as viewed along line 3-3 of FIG. 1.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

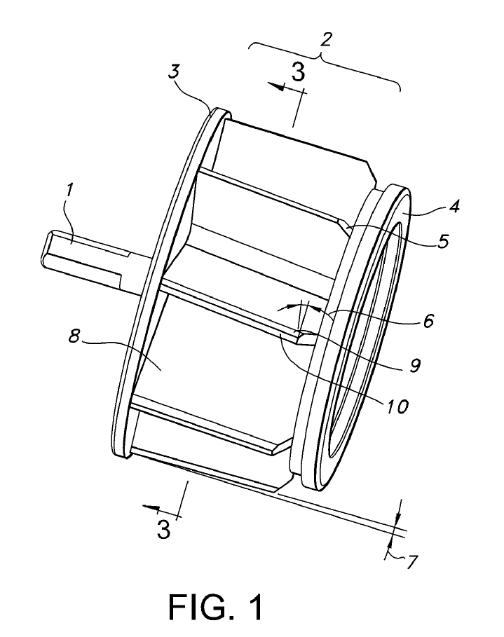

Referring to the drawings, FIG. 1. illustrates an exemplary embodiment of the reamer. The reamer has a shaft 1, which may be shaped so that it can be easily gripped by a rotating driver, such as a handheld drill. The shaft 1 extends through the body of the reamer and terminates at a distal end of the reamer, referred to herein as the leading end. This leading end is the side of the reamer opposite the rotating driver and which will first enter into the hole to be enlarged. The body of the reamer includes a cutter assembly 2 which is bounded by a stop plate 3 on the rotating driver side of the reamer and a pilot plate 4 on the leading end of the reamer.

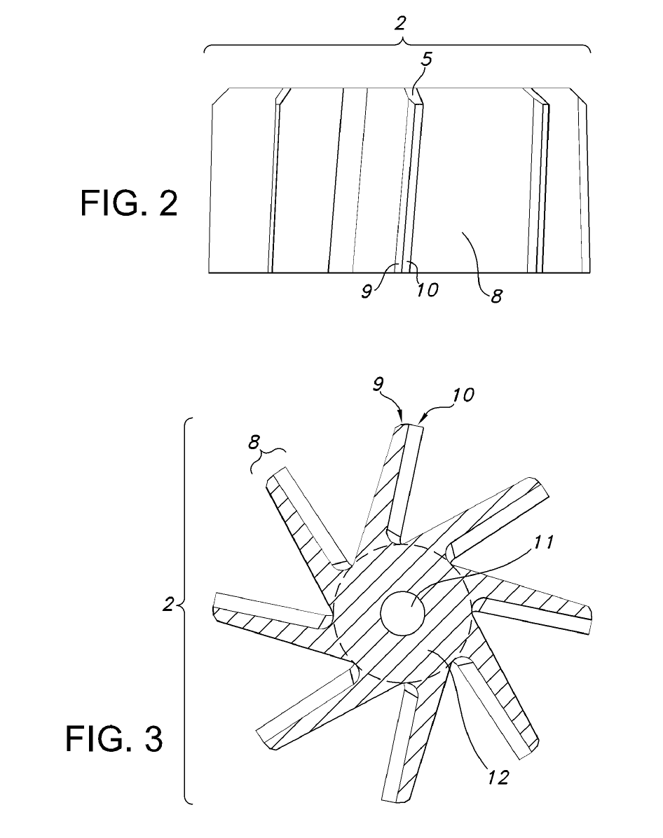

As can be seen from FIG. 2 and FIG. 3, the cutter assembly 2 consists of blades 8 which extend outward from a cylindrical central hub 12, affixed to shaft 1. The reamer has at least two blades 8, which are equally-spaced apart to provide balance and stability to the reamer. As the shaft 1 rotates, it causes the cutter assembly 2, including the blades 8, to rotate with it. The blades 8 may either be straight, spiral, or as depicted in FIG. 2, inclined.

The reamer culminates at the leading end with a pilot plate 4. The diameter of the pilot plate 4 is slightly smaller than the diameter of the hole which will be enlarged by the reamer. The pilot plate 4 allows the leading end of the reamer to be placed into the hole to be enlarged. The pilot plate 4 may be permanently attached to the shaft 1 and cutter assembly 2, or it may be removable so that it can be interchanged with different-sized pilot plates based on the size of the hole to be enlarged.

The leading end of each of the blades 8 terminates in an angled face 5. Some of the angled faces 5 extend axially toward the leading edge and make contact into the material to be cut; these are known as cutting faces. Other angled faces 5 do not extend axially toward the pilot plate 4 as far as the cutting faces and do not come into contact with the material being cut away; these are known as non-cutting faces. Preferably, the difference between lengths of blades 8 with cutting faces and the lengths of the blades 8 with non-cutting faces is as small as possible so that the reamer does not become unbalanced by unequally distributed weights of blades. In a preferred embodiment, that difference is twenty-thousandths of an inch.

The cutting faces engage the material to be cut away at an angle that will allow the material to be removed without gouging it. For softer material, such as plastic, the preferred angle is approximately three degrees. Larger angles increase the likelihood that the reamer tool will gouge the walls of the hole and bind, or result in chattering of the tool and uneven cuts. The non-cutting faces may also have zero degree primary relief angles to prevent the blades 8 from cutting into the material being removed, thus further reducing the likelihood that they will engage the material being cut away if the reamer tool shifts during operation.

The blades 8 may have a chamfered edge 9 and a flat edge 10 along the side of the blade generally parallel to the shaft. This chamfered edge 9 is angled to further reduce contact with the sidewalls of the enlarged hole, thus reducing the torque required. The flat edge 10 is at an almost zero degree primary relief angle to prevent the blade from gouging the sidewall of the hole.

To use the reamer tool, the shaft 1 is attached to a rotary drive, such as a drill. The pilot plate 4 is inserted into the hole that the reamer operator would like to enlarge. When the rotary drive is engaged, the reamer rotates. The cutting faces on the blades 8 of the cutter assembly 2 cut into the material at the leading end of the reamer. This removes material at the lip of the hole. As material is removed by the reamer in the path of the cutting faces, the cutter assembly 2 gradually enters the hole. The maximum depth of the enlarged hole is dependent on the length of the blades 8; longer blades will allow for deeper cuts. The stop plate 3 prevents the reamer from making the enlarged hole any deeper than the length of the blades 8.

The reamer tool may be machined from a single piece of metal, welded together, or preferably, the shaft 1 is keyed such that the stop plate 3 and cutter assembly 2 may slide onto the shaft but may not spin freely of the shaft. At the leading end of the reamer tool, the shaft is male screw-threaded. The pilot plate 4 in this embodiment is female screw-threaded. The cutter assembly 2 and stop plate 3 are secured to the shaft 1 by screwing the pilot plate 4 until it is tightly pressed against the cutter assembly 2. The advantage of this embodiment is that different pilot plates 4 could be screwed into place to accommodate various diameters of the hole that is to be enlarged.

The reamer can be made of any hard material, such as metal, that can withstand the rotational and axial force required by the material being cut away. In one embodiment, the tool is made completely of hardened tool steel. In another embodiment, the stop plate 3 and pilot plate 4 are made of aluminum to further reduce the weight and torque required to drive the reamer tool.

The torque required by the disclosed reamer is less than previously known reamers. This allows it to be used in applications where the rotary driver has lower torque, such as in a handheld drill.

The examples discussed below show the reamer in use on PVC conduit. Although these examples are chosen to demonstrate the ability of the reamer to perform in situations where reamers of previous designs could not, the reamer can be used on any material, and on solid surfaces, as well as pipes.

In a first embodiment, a reamer tool was constructed to remove approximately half of the inner wall material of a three inch diameter schedule 40 nonmetallic conduit. Due to the large size of this pipe, several blades would be required to provide stability of the reamer. For this larger sized reamer, a six-blade configuration was chosen. However, only three of the six blades 8 had cutting faces on them. The three non-cutting faces add stability but are designed to add little to the torque requirements of the reamer. These non-cutting faces have zero-degree primary relief angles to prevent them from biting into the inner sidewalls of the conduit. Additionally, the non-cutting faces were recessed back axially from the cutting end faces, but only slightly, so that the tool was balanced and stable as it was started with the pilot plate 4 positioned in the conduit.

In a second embodiment, a reamer tool was constructed to remove approximately half of the inner wall material of a four-inch diameter schedule 40 nonmetallic conduit. In order to provide stability for this even larger sized reamer, it had eight blades 8. However, only one of the eight blades 8 had a cutting face. The seven non-cutting faces were provided to ensure that the tool was stable. These non-cutting faces did not have primary relief angles. As in the previous example, the non-cutting faces were recessed back axially from the cutting end faces, but only slightly so that the tool was balanced and stable as it was started with the pilot plate 4 positioned in the conduit.

The cutter assembly 2 may optionally be tapered for applications in which a socket is required with the distal end narrower than the opening. This is common in applications involving PVC pipe fittings in which the pipe fitting has a narrower end than its opening so that the PVC pipe can be inserted only to a maximum distance. This is typical of the applications in which a conduit is tapered to accept a solvent cement-able fitting which has a male mating taper. The mating tapers help create strong adhesive joints. The degree of tapering 7 will vary based on the preferred slope of the taper.

Embodiments that included a tapered cutter assembly were built to remove material and to taper the inside of both a three inch and a four inch schedule 40 nonmetallic conduit so that these conduits could accept a solvent cement-able fitting. Both of these embodiments had zero primary relief angles on the flat edge 10 of the blades 8 of the cutting assembly 2 to further reduce torque. The flat edge 10 of the blades 8 cut a tapered hole as the reamer advanced into the inside of the conduit. The primary relief angle on the flat edge 10 of the blades 8 had a very low primary relief angle of zero degrees to prevent the blades 8 from cutting aggressively and generating large resistive torques.

An additional method of reducing the required torque is to have a portion along the axial edge of the blades 8 removed. The reduced contact with the sidewalls of the holes results in lowered torque requirements. Preferably, diagonal grooves would be cut into each blade at varying lengths along chamfered edge 9 and flat edge 10. If the grooves are spread out equally between the blades 8 so that each section is offset from the other in a stepped spiral pattern, there is an added benefit in that the rotation of the reamer helps remove cut material from the enlarged hole.

It should be understood that features of any of these embodiments may be used with another in a way that will now be understood in view of the foregoing disclosure. Although the present invention has been described and illustrated with respect to at least one preferred embodiment and use therefor, it is not to be so limited, since modifications and changes can be made therein which are within the fully-intended scope of the invention.

We claim:

1. A device for enlarging a hole comprising:
a. a cutter assembly having a rotational axis;
b. a plurality of blades formed in the cutter assembly positioned about the rotational axis; and
c. cutting faces on less than all of the blades in said plurality of blades, said cutting faces configured to remove material from the inner surface of said hole.

2. The device of claim 1 further comprising a shaft configured for attachment to a handheld drill.

3. The device of claim 1 further comprising:
d. an edge on each blade of the plurality of blades facing the sidewall of the hole, wherein said edge has a primary relief angle of between zero and three degrees.

4. The device of claim 1 wherein less than all of the blades in said plurality of blades extend axially into the material at the inner surface of said hole.

5. The device of claim 1 wherein at least one blade in a plurality of blades has a chamfered edge.

6. The device of claim 1 further comprising:
d. a pilot plate, said pilot plate configured to fit within the opening of said hole; and
e. a stop plate, said stop plate configured to limit the depth of the hole being enlarged.

7. The device of claim 6 wherein said pilot plate is permanently affixed to said cutter assembly, and said cutter assembly is permanently affixed to said stop plate.

8. The device of claim 5 further comprising:
d. a shaft extending through the center of said stop plate and cutter assembly, said shaft having a male threaded end; and
e. a female threaded center hole in said pilot plate for threadably coupling with said male threaded end.

9. The device of claim 6 wherein said pilot plate and said stop plate are made of aluminum.

10. The device of claim 1 wherein said cutting assembly is tapered along the rotational axis such that the proximal end of each blade in the plurality of blades protrudes farther from the rotational axis than the distal end, said distal end being closer to the cutting faces.

11. The device of claim 1 wherein said blades have grooves cut into the sides parallel to the rotational axis in a stepped spiral pattern.

12. A device for enlarging a hole comprising:
a. a cutter assembly having a rotational axis;
b. a plurality of blades formed in the cutter assembly positioned about the rotational axis; and
c. an edge on each blade of the plurality of blades facing the sidewall of the hole, wherein said edge has a primary relief angle of between zero and three degrees.

13. The device of claim 12 further comprising a shaft configured for attachment to a handheld drill.

14. The device of claim 12 wherein less than all of the blades in said plurality of blades extend axially into the material at the inner surface of said hole.

15. The device of claim 12 wherein at least one blade in a plurality of blades has a chamfered edge.

16. The device of claim 12 further comprising:
d. a pilot plate, said pilot plate configured to fit within the opening of said hole; and
e. a stop plate, said stop plate configured to limit the depth of the hole being enlarged.

17. The device of claim 16 wherein said pilot plate is permanently affixed to said cutter assembly, and said cutter assembly is permanently affixed to said stop plate.

18. The device of claim 16 further comprising:
f. a shaft extending through the center of said stop plate and cutter assembly, said shaft having a male threaded end; and
g. a female threaded center hole in said pilot plate for threadably coupling with said male threaded end.

19. The device of claim 16 wherein said pilot plate and said stop plate are made of aluminum.

20. The device of claim 12 wherein said cutting assembly is tapered along the rotational axis such that the proximal end of each blade in the plurality of blades protrudes farther from the rotational axis than the distal end, said distal end being closer to the cutting faces.

21. The device of claim 12 wherein said blades have grooves cut into the sides parallel to the rotational axis in a stepped spiral pattern.
